(19) United States
(12) Patent Application Publication
(10) Pub. No.: US 2026/0132628 A1
(43) Pub. Date: May 14, 2026

(54) W-SHAPED STRUCTURAL BEAM ASSEMBLY FOR USE IN A FOAM FILLED STRUCTURAL PLANK

(71) Applicant: PLANK STRUCTURAL SYSTEMS LLC, Mill Valley, CA (US)

(72) Inventors: David WARNER, Mill Valley, CA (US); James BABCOCK, Mill Valley, CA (US)

(73) Assignee: PLANK STRUCTURAL SYSTEMS LLC, Mill Valley, CA (US)

(21) Appl. No.: 19/376,239

(22) Filed: Oct. 31, 2025

Related U.S. Application Data
(60) Provisional application No. 63/719,564, filed on Nov. 12, 2024.

(51) Int. Cl. E04C 3/08; B32B 3/18; B32B 5/02; B32B 5/18; B32B 15/04; E04B 5/02; E04C 2/284; E04C 2/34

(52) U.S. Cl. CPC E04C 3/08; B32B 3/18; B32B 5/028; B32B 5/18; B32B 15/046; E04C 2/284; E04C 2/34; E04C 2/50; B32B 2262/06; B32B 2262/106; B32B 2266/0228; B32B 2307/718; B32B 2307/72; B32B 2307/7265; B32B 2311/30; B32B 2419/00; E04C 2002/3488

(57) ABSTRACT

A structural plank assembly, including: (a) a plurality of structural beams connected together to define a structural plank building foundation; (b) a bottom wall; (c) a top wall; and (d) a structural foam filling the enclosure, and wherein at least one of the structural beams includes: (i) a top planar member; (ii) a bottom planar member; (iii) two or more vertical end members connected to the top planar member and to the bottom planar member; and (iv) a series of repeating angled planar members, each angled planar member being connected to the top planar member and to the bottom planar member.

### RELATED APPLICATION

The present application claims priority to U.S. Provisional Patent Application Ser. No. 63/719,564, of same title, filed Nov. 12, 2024, the entire disclosure of which is incorporated herein by reference in its entirety for all purposes.

### TECHNICAL FIELD

The present invention relates to structural planks, including structural planks for use in building foundations.

### BACKGROUND OF THE INVENTION

The present inventors have created new and unique building structural planks that display excellent building properties. Examples of such building structural planks, and their features and advantages are found in U.S. Pat. Nos. 11,851,875 and 11,814,841, entitled “Foam Filled Structural Plank Building Foundation With Laminated Reinforcement”, both incorporated herein by reference in their entireties for all purposes.

As described in these two patents, these foam filled structural planks avoided using concrete. As a result, they therefore have substantially reduced embodied carbon as compared to traditional concrete foundations. In addition, these structural planks are lightweight and they can be manufactured remotely and then delivered to the jobsite. They are quickly installable with minimal personnel working in all kinds of weather.

In spite of the fact that they are foam filled, the structural planks described in these two patents have been experimentally shown to be sufficiently strong to support the weight of buildings thereon. Although the structural planks described in these two patents display excellent performance characteristics, the desire to continue to improve upon their performance properties continues to exist. As will be shown, the present novel structural beam design offers such enhanced performance characteristics.

### SUMMARY OF THE INVENTION

The present invention provides a structural beam assembly for use in a foam filled structural plank. The present structural beam assembly has a novel shape with optimized performance properties. In preferred aspects, the present structural beam assembly comprises:
a top planar member;
a bottom planar member;
   two or more vertical end members, each vertical end member being connected to the top planar member and to the bottom planar member;
   a series of repeating angled planar members, each angled planar member being connected to the top planar member and to the bottom planar member.

In preferred embodiments, the repeating angled planar members are disposed at 35 to 75 degree angle to the top and bottom planar members. In some embodiments, this angle can be 45 degrees. Specifically, the top ends of two repeating angled planar members are connected together at the top planar member and the bottom ends of the two repeating angled planar members are connected together at the bottom planar member. As such, the sequential repeating angled planar members are angled in opposite directions an form a repeating W-shaped pattern. Preferably, the height of the structural beam assembly is approximately 5 times the width of the structural beam assembly, and the structural beam assembly is preferably made of a light gauge steel.

The present inventors have experimentally determined that this novel and uniquely shaped structural beam assembly provides superior strength over standard commercially available light weight metal studs and when in direct contact with the foam adds to the torsional stability of the assembly as a whole. This uniquely shaped structural beam is lighter in weight and able to support heavier loads. The support beam assembly is preferably made of a light gauge steel. The structural foam may be an expanded polystyrene foam.

In other preferred embodiments, the present invention provides a structural plank assembly, comprising:
a plurality of structural beams connected together to define a structural plank building foundation, wherein the structural beams define an enclosure therebetween and an outer perimeter therearound;
a bottom wall on the enclosure;
a top wall on the enclosure; and
a structural foam filling the enclosure, the structural foam being in direct contact with the structural beams and with the top wall and the bottom wall of the enclosure, and
wherein at least one of the structural beams comprises:
   a top planar member;
   a bottom planar member;
   two or more vertical end members, each vertical end member being connected to the top planar member and to the bottom planar member;
   a series of repeating angled planar members, each angled planar member being connected to the top planar member and to the bottom planar member.

The structural foam is in direct contact with the structural beams and with the top wall and the bottom wall of the enclosure, and at least one of the structural beams in the structural plank is of the above-described shape.

In preferred embodiments, at least one of the top and bottom walls may comprise a laminate panel, and the laminate panel may comprise at least one of the following: (a) a fabric mesh, (b) a fossil fuel mesh including, Rayon, Polypropylene or Nylon, having a weight from 1.5 to 16 oz./square yard, (c) a carbon based mesh including, graphene or Kevlar, having a density from 170 g/m3 to 300 g/m3 (or 210-250 g/m3, or 180-290 g/m3), (d) a plant based mesh, including but not limited to hemp or burlap, (e) a synthetic acrylic or cementitious composites, (f) a product made by a pultrusion process including fiberglass, graphene, carbon, glass fiber reinforced carbon, or fiberglass based, or (g) wood based panel products including, cellulosic panels; plywood, Medium Density Fiberboard, Medium Density Overlay, Oriented Strand Board, plywood panels, bamboo board,, flaxboard, particleboard, or strawboard.

### BRIEF DESCRIPTION OF THE DRAWINGS

FIG. 1 is a sectional perspective view of a section of the present structural beam.

FIG. 2 is a top perspective view of an exemplary structural plank.

FIG. 3 is a top plan view of the structural plank of FIG. 2.

FIG. 4 is a sectional elevation view through the structural plank of FIG. 3 taken along line 4-4.

### DETAILED DESCRIPTION OF THE DRAWINGS

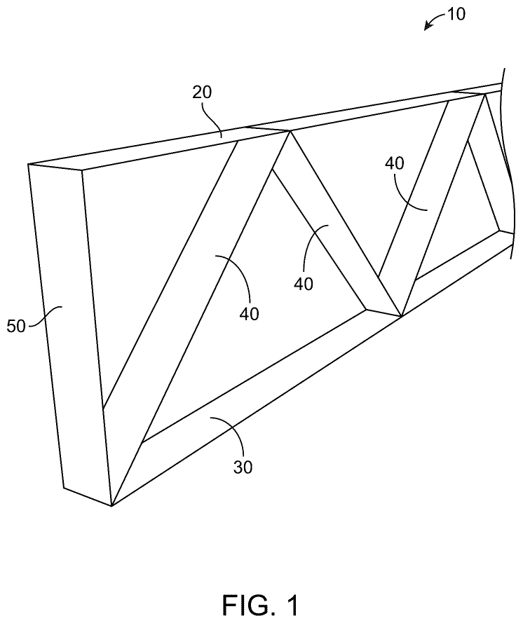

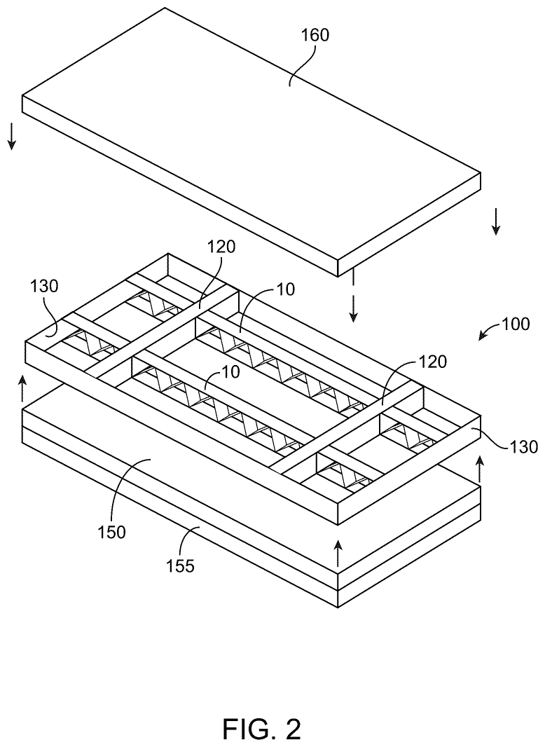

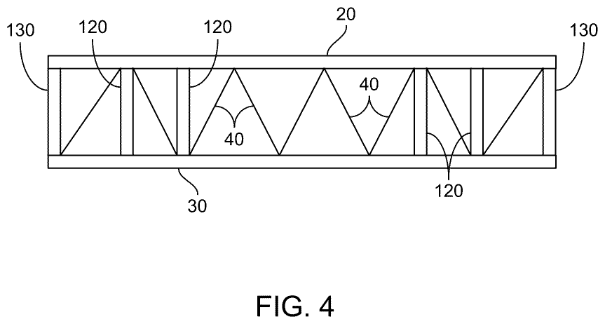

FIG. 1 shows a view of the present structural beam. FIGS. 2 to 4 show view of an exemplary structural plank incorporating several of the structural beams of FIG. 1. Referring first to FIG. 1, the present system provides a structural beam assembly 10 for use in a foam filled structural plank. In preferred embodiments, structural beam 10 comprises a structural beam assembly for use in a foam filled structural plank, comprising: a top planar member 20; a bottom planar member 30; repeating angled planar members 40 and vertical end member 50.

As can be seen, each of the repeating angled planar members 40 is connected to the top planar member 20 at its top end and to the bottom planar member 30 at its bottom end. As can also be seen, the repeating angled planar members 40 are disposed at 45 degree angles to the top and bottom planar members 20 and 30. Specifically, the top ends of two angled planar members 40 meet at top member 20 and the bottom ends of two angled planar members 40 meet at bottom member 30. As can also be seen, sequential repeating angled planar members 40 are angled in opposite directions next to one another, and are perpendicular to one another. As such, repeating angled planar members 40 form a repeating W-shaped pattern.

In preferred embodiments, the height of the structural beam assembly 10 is approximately 5 times its width, and the structural beam assembly 10 is made of a light gauge steel.

FIGS. 2 to 4 illustrate a structural plank assembly 100 that incorporates one or more of structural beams 10 therein. The structural plank assembly 100 described herein can optionally correspond to the structural plank assembly described in U.S. Pat. Nos. 11,851,875 and 11,814,841, both entitled “Foam Filled Structural Plank Building Foundation With Laminated Reinforcement”, both incorporated herein by reference in their entireties for all purposes. In various embodiments, the present structural plank assembly 100 can be used as a building foundation. However, as will be shown, using the present techniques of formation and assembly, the present structural plank system can also be used as or in a building wall, ceiling, or roof.

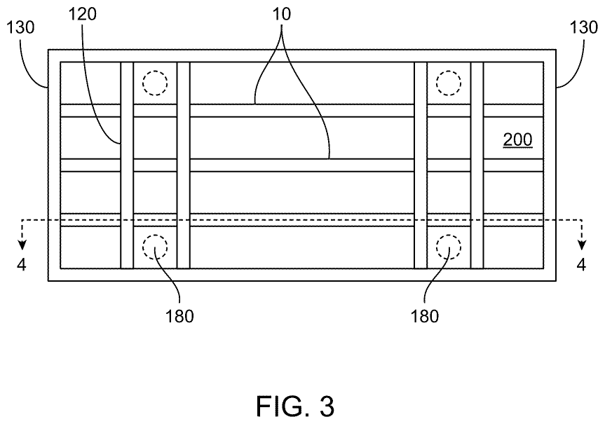

As seen in FIGS. 2 and 3, structural plank assembly 100 comprises a plurality of structural beams 10, 120 and 130, connected together to define a structural plank building foundation, wherein the structural beams define an enclosure therebetween and an outer perimeter therearound. As illustrated, the present plank includes beams 10, 120 and 130. It is to be understood that any or all of these beams 10, 120 and 130 may correspond to the design of beams 10 in FIGS. 1 to 3. Structural plank assembly 100 also includes a bottom wall 150 on the enclosure; and a top wall 160 on the enclosure.

In its various aspects, the present building foundation 100 provides a factory-deployable system to support building structures thereon. Advantageously, the buildings supported on the present building foundation can be pre-fabricated, modular, site-built or manufactured buildings. Bottom wall 150 may optionally be made of aluminum, steel or other suitable metal. Thereafter, the structural building foam sets and hardens in place. At the jobsite, an optional waterproofing layer 155 may be applied below bottom wall 150 (i.e., between building plank 100 and the ground), as desired.

A structural foam 200 fills the enclosure. Structural foam 200 is preferably in direct contact with the structural beams 10, 20 and 30 and with the top wall 120 and the bottom wall 110 of the enclosure. This offers weight loading advantages such as the foam fills all the voids and creates a torsion box application due to the foam being in contact with all the faces of the structure (top sheet, bottom sheet, metal structural members. In preferred aspects, the structural foam is an expanded polystyrene foam having a density from 1.5 to 3.0 PFC (pound-force per cubic foot). In preferred embodiments, the structural foam used may be Geocell foam made by Geocell Products Group of Cleveland, OH. The present structural foam has the advantages of being lightweight, having a low density, offering thermal insulation benefits, having a long-life performance, and having limited water absorption. It is to be understood, however, that the present system is not limited to the use of this particular foam or any other type of foam. As such, the present system encompasses a wide variety of various open and closed cell foams.

The present system also provides a method of forming a foam filled structural plank building foundation, comprising: assembling a plurality of structural beams together to form a structural plank building foundation, wherein the plurality of structural beams define an enclosure therebetween and an outer perimeter therearound; and then filling the enclosure with a structural building foam; and then permitting the structural building foam to set.

The structural foam used in the present building foundation offers other advantages. First, the foam is an insulator (giving the entire building foundation assembly a good R-value). In addition, ducting and ducting manifolds, chase ways, and utility knockouts can all be cut into the structural foam when the building foundation is first being assembled in the factory. Preferably, the present foam is an environmentally benign material that does not leach into the atmosphere. As a result, the air ducting HVAC passageways cut in the foam do not require air pipes therein. Rather, air can simply be passed through the ducting passageways directly and thus throughout the building.

As can also be seen, all of beams 10, 120 and 130 may preferably have the same vertical height such that all of the separate enclosures have the same vertical height. This makes it very easy to fill foam to the same level across the entire structural plank building foundation 100.

As was described in U.S. Pat. Nos. 11,851,875 and 11,814,841, a first advantage of the present building foundation 100 is that it does not require any concrete. Concrete is an environmentally damaging material in terms of the embodied carbon required in its formation. Therefore, avoiding concrete results in a much more environmentally desirable system. In addition, concrete placement is dependent upon the environmental conditions of the day and its time to reach full strength is not fully predictable. For example, although it may only take a week for concrete to reach 80-90% of its full strength, it is possible that it may take as long as a month to reach full strength. In contrast, the strength of the present system is completely predictable as it is built in a factory and can be delivered to the jobsite rain or shine. In addition, whereas concrete takes a long time to reach its full strength, the present system operates at full strength right at the outset. There is no need to wait for the present system to strengthen at the job site. In addition, there is no need to wait for good weather conditions to install the present system. The present system thus speeds up construction time.

Other advantages of the present building foundation plank 100 are that it can be assembled quickly and is very lightweight. Preferably, the present building foundation is made of steel or aluminum (to form the structural “cage” or enclosure) and foam (that is poured in to fill the cage). After the foam solidifies, the plank structure can then be moved to the jobsite. Steel, aluminum and the foam used are all recyclable. In contrast, traditional concrete is not recyclable.

Another advantage of the present building foundation is that its structural members can be connected to the structural members of an adjacent building foundation. As such, for larger buildings, a plurality of the present building foundations can be delivered to a jobsite and then connected together to form a larger building foundation.

Another advantage of the present building foundation is that it can accept dead loads, lateral loads, wind loads and can accommodate loading due to sub-grade pressures and voids required to support a building.

Another advantage of the present building foundation is that its structural members can be provided with wall connections such that vertical building walls can be mounted directly to the present structural building foundation.

In optional preferred aspects, the structural plank building foundation 100 can optionally be mounted onto an array of building piers 180 in FIG. 2, with inner support walls positioned against the building piers. Such mounting may either be done with the structural plank building foundation resting on the ground, or above ground resting on the array of piers.

In preferred embodiments, as seen in FIG. 2, at least one of the top wall 150 and the bottom wall 160 is a laminate panel. Alternatively or additionally, laminate panels may instead extend across an inner portion of the structural plank. The various laminate panels operate to provide exceptional strength to the structural plan when the laminate panels are adhered to or positioned within the structural plank. The laminate panels may optionally be adhered to the structural plank by thermal-set epoxy or glue.

In preferred embodiments, the laminate panel comprises at least one of the following: (a) a fabric mesh, (b) a fossil fuel mesh including, Rayon, Polypropylene or Nylon, having a weight from 1.5 to 16 oz./square yard, (c) a carbon based mesh including, graphene or Kevlar, having a density from 170 g/m3 to 300 g/m3 (or 210-250 g/m3, or 180-290 g/m3), (d) a plant based mesh, including but not limited to hemp or burlap, (e) a synthetic acrylic or cementitious composites, (f) a product made by a pultrusion process including fiberglass, graphene, carbon, glass fiber reinforced carbon, or fiberglass based, or (g) wood based panel products including, cellulosic panels; plywood, Medium Density Fiberboard, Medium Density Overlay, Oriented Strand Board, plywood panels, bamboo board, flaxboard, particleboard, or strawboard.

What is claimed is:

1. A structural beam assembly for use in a foam filled structural plank, comprising:
a top planar member;
a bottom planar member;
two or more vertical end members, each vertical end member being connected to the top planar member and to the bottom planar member;
a series of repeating angled planar members, each angled planar member being connected to the top planar member and to the bottom planar member.

2. The assembly of claim 1, wherein the repeating angled planar members are disposed at 45 degree angles to the top and bottom planar members.

3. The assembly of claim 1, wherein the top ends of two repeating angled planar members are connected together at the top planar member and the bottom ends of the two repeating angled planar members are connected together at the bottom planar member.

4. The assembly of claim 1, wherein sequential repeating angled planar members are angled in opposite directions.

5. The assembly of claim 1, wherein sequential repeating angled planar members are angled at 90 degrees to one another.

6. The assembly of claim 1, wherein the series of repeating angled planar members forms a repeating W-shaped pattern.

7. The assembly of claim 1, wherein the height of the structural beam assembly is approximately 5 times the width of the structural beam assembly.

8. The assembly of claim 1, wherein the structural beam assembly is made of a light gauge steel.

9. A structural plank assembly, comprising:
a plurality of structural beams connected together to define a structural plank building foundation, wherein the structural beams define an enclosure therebetween and an outer perimeter therearound;
a bottom wall on the enclosure;
a top wall on the enclosure; and
a structural foam filling the enclosure, the structural foam being in direct contact with the structural beams and with the top wall and the bottom wall of the enclosure, and
wherein at least one of the structural beams comprises:
a top planar member;
a bottom planar member;
two or more vertical end members, each vertical end member being connected to the top planar member and to the bottom planar member;
a series of repeating angled planar members, each angled planar member being connected to the top planar member and to the bottom planar member.

10. The assembly of claim 9, wherein the repeating angled planar members are disposed at 45 degree angles to the top and bottom planar members.

11. The assembly of claim 9, wherein the top ends of two repeating angled planar members are connected together at the top planar member and the bottom ends of the two repeating angled planar members are connected together at the bottom planar member.

12. The assembly of claim 9, wherein sequential repeating angled planar members are angled in opposite directions.

13. The assembly of claim 9, wherein sequential repeating angled planar members are angled at 90 degrees to one another.

14. The assembly of claim 9, wherein the series of repeating angled planar members forms a repeating W-shaped pattern.

15. The assembly of claim 9, wherein the height of the structural beam is approximately 5 times the width of the structural beam.

16. The assembly of claim 9, wherein the structural beam is made of a light gauge steel.

17. The assembly of claim 9, wherein at least one of the top and bottom walls is a laminate panel.

18. The assembly of claim 17, wherein the laminate panel comprises at least one of the following:
(a) a fabric mesh,
(b) a fossil fuel mesh having a weight from 1.5 to 16 oz./square yard,
(c) a carbon based mesh having a density from 170 g/m3 to 300 g/m3 (or 210-250 g/m3, or 180-290 g/m3),
(d) a plant based mesh,
(e) a synthetic acrylic or a cementitious composite,
(f) a product made by a pultrusion process, or
(g) a wood based panel product.

19. The assembly of claim 9, wherein the structural foam is an expanded polystyrene foam.
